(19) United States
(12) Patent Application Publication
(10) Pub. No.: US 2007/0003362 A1
(43) Pub. Date: Jan. 4, 2007

(54) Ball and socket coupling assembly

(76) Inventor: Stephen E. Parent, Louisville, KY (US)

Correspondence Address: David W. Carrithers;CARRITHERS LAW OFFICE, PLLC, One Paragon Centre, 6060 Dutchman's Lane, Suite 140, Louisville, KY, 40205, US

(21) Appl. No.: 11/171,485

(22) Filed: Jun. 30, 2005

(51) Int. Cl. F16C 11/00

(52) U.S. Cl. 403/122

(57) ABSTRACT

A quick, snap, disconnect ball and socket coupling assembly principally for use for controlling air release during engagement and disengagement of the ball and socket members affixed to separate cooperatively engaging members

### FIELD OF INVENTION

This invention relates generally to a quick connect, snap together, coupling consisting of a ball and a socket or socket sleeve securable to a respective one of a pair of members and in which the coupling has an air chamber that serves as an cushion when coupling together the pair of members and as a suction chamber when detaching the members.

### BACKGROUND OF INVENTION

There are numerous examples of one member having a projection that slip fits into a socket in another member to join them together and the following United States patents are examples of some considered related to applicants proposal:
U.S. Pat. No. 6,000,820 granted Dec. 14, 1999 to K. J. Murray;
U.S. Pat. No. 5,453,729 granted Sep. 26, 1995 to Chin-Tsai Chu
U.S. Pat. No. 5,294,924 granted Mar. 15, 1994 to Dmytro Dydzyk;
U.S. Pat. No. 1,237,035 granted Aug. 14, 1917 to F. B. Hyden; and
Des 419,256 granted Jan. 18, 2000 to L. A. Meck et al

U.S. Pat. No. 6,000,280 discloses a low voltage light novelty item with a cavity extending upwardly into the bottom end thereof and into which projects a cylindrical enlargement on the upper end of a post or equivalent mounting device.

U.S. Pat. No. 5,453,729 discloses a solar warning light having a spigot extending downwardly from the bottom thereof for projecting into an open upper end of a post or into a hole in the upper end of a traffic cone.

U.S. Pat. No. 5,294,924 discloses a tapered plug detachably mounted on the bottom of a warning light and projecting downwardly for insertion into a hole in the top end of a traffic cone.

U.S. Pat. No. 1,237,035 discloses a lamp with a downwardly projecting generally cylindrical part that projects into the upper open end of a cylindrical member.

None of the forgoing employ the concept of having an air chamber to serve as a cushion when joining the two parts together and serving as a resistance when separating one part from the other. Also, the foregoing are dedicated to the particular respective items being joined together.

### SUMMARY OF INVENTION

The device comprises a ball attached to any object such as a door. The socket is comprised of a sleeve forming a cylinder having an end and an internal diameter whereby the inner portion of the sleeve next to the end wall is of greater inside diameter than the portion of the sleeve adjacent to the outer open end. The ball will slip through the narrower opening with only slight expansion of the sleeve if any. Thus, slamming a door will allow the ball to extend into a sleeve mounted onto the wall allowing air to exit around the sleeve slowing the door, but not stopping it from shutting. Moreover, pulling on the door will cause a slight vacuum to form in the sleeve resisting the pull. Thus, the device provides a controlled pulling and pushing resistance to attaching and detaching a device held together by the ball and sleeve socket coupling arrangement.

The present invention comprises a ball attached to a selected object such as a door or post. A socket comprised of elastomeric or pliable resilient material forms a sleeve or cylinder having an end and an internal diameter whereby the inner portion of the sleeve next to the end wall abutting the door, post or other attachment support is of greater inside diameter than the portion of the sleeve adjacent the outer open end. Upon exertion of force, the ball will contact and slip through the narrower opening of the sleeve with only slight expansion of the sleeve if any. Thus, slamming a door connecting the ball with the sleeve or socket allows the ball to extend into a sleeve mounted onto the wall and allows the air to exit between the ball and sleeve thereby providing an air cushion slowing the door, but not stopping it. Moreover, pulling on the door will cause a slight vacuum to form within the sleeve to resist the pull and control rate of opening.

A principal object of the present invention is to provide a simple coupling for detachably interconnecting two of a multiplicity of different members.

One object of the present invention is to provide a simple door abutment to cushion the door's engagement therewith and that also serves to retain the door in a door open position.

Another object of the present invention is to provide a quick disconnect coupling for mounting a lamp on the upper end of a post like support.

The present invention comprises a coupling for detachably interconnecting a pair of members comprising a first ball-shaped member and means on a first member for securely attaching the same to one of a pair of members. The pair of members includes a second member having a cavity for receiving therein the first member. Means on the second member is provided for securely attaching the same to the other one of the pair of members. The socket has a throat entry into the cavity. The first member has an outer dimension greater than that of the throat providing an interference or friction fit during insertion and removal of the first member respectively into and out of the cavity.

These and other objects will become more apparent from reading the following description in conjunction with the accompanying drawing.

### BRIEF DESCRIPTION OF THE DRAWINGS

A better understanding of the present invention will be had upon reference to the following description in conjunction with the accompanying drawings in which like numerals refer to like parts throughout the several views and wherein:

FIG. 1 is a part sectional top view of a coupling of the present invention employed as a door stop;

FIG. 2 is an elevational view of a modified form of the coupling shown in FIG. 1;

FIG. 3 is a top plan view of the coupling shown in FIG. 2;

FIG. 4 is a perspective view of a ball mounted onto a plate and a grommet for insertion into a cavity;

FIG. 5 is a perspective exploded view of the plate, ball, grommet, of FIG. 4 together with a lamp base;

FIG. 6 is a picture of the assembled ball and socket assembly together with the lamp base and lamp; and

FIG. 7 shows a cutaway view of the lamp base and lamp of FIG. 6 wherein the ball is biased and held by the constriction of the socket.

### DETAILED DESCRIPTION OF PREFERRED EMBODIMENT

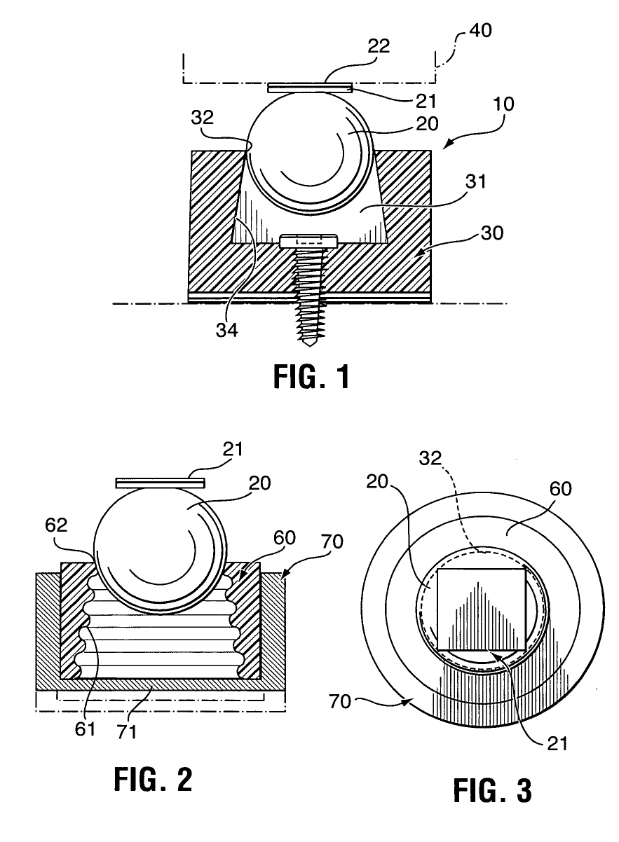

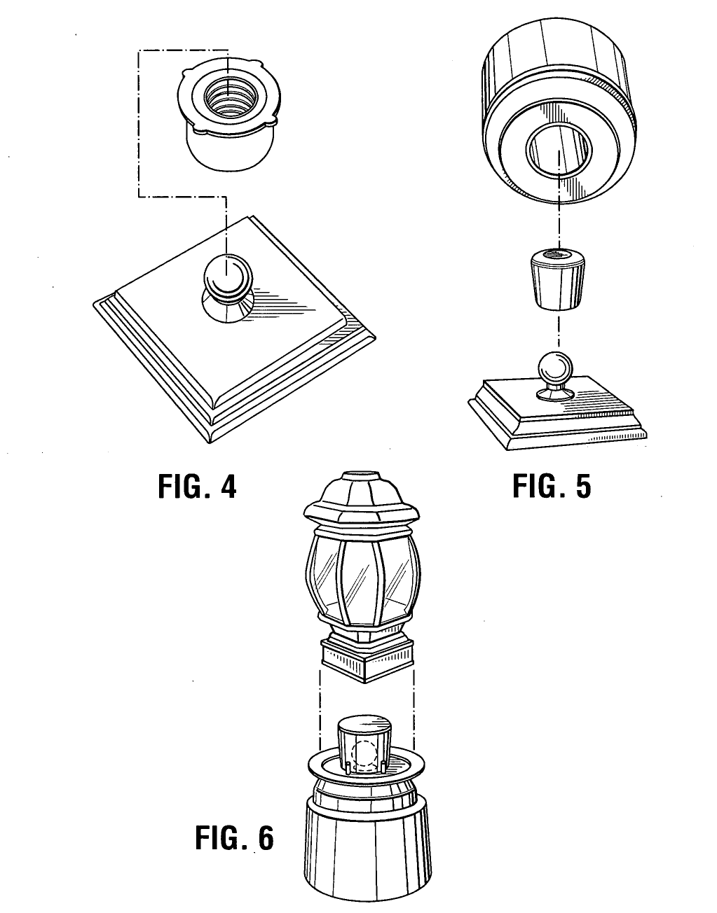

Referring to FIG. 1 there is illustrated, part in section, a coupling 10 comprising a first member 20, in the form of a ball or generally spherical, elliptical, or cylindrical shaped member whereby the cylindrical shaped member has a interior portion of a larger diameter than at least one of the distal end portions; and a second member 30 having a socket or socket sleeve 31 for receiving the ball shaped member 20 therein. The socket/socket sleeve has at least a portion of the throat 32 that is smaller than the outer dimension of the member 20. The smaller diameter portion of the throat can be formed at the distal end of the throat opposing the ball, or at one or more selected points between the distal end of the throat opposing the ball and a point within the throat greater than the length of the ball cooperatively engaging the throat. One of the two member has a resilient portion that engages the other thereby permitting forcing the two members together.

One preferred embodiment provides that the member 20 is attachable, by way of example, to a door 40 by a mounting means 21 in the form of a plate that is suitably anchored to the member 20 by rivets, screws, adhesives, hook and loop attachment means, or integrally formed therein and attaches to the door by holding means such as by an adhesive, a strip of double faced tape 22 or screws, rivets, nails. staples and the like.

As shown in the FIG. 1, the member 30 is preferably made of a resiliently flexible material and is fastenable to a wall 50 by a strip of double faced tape 33. A screw 34 can also be used for a secure fastening and similarly the plate 21 can also have screws there through into the door for a secure fastening. The members 20 and 30 are so located respectively on the door and the wall that the ball and socket are aligned when the door in it's open stop position.

The member 20 maybe spherical or elliptical and has an outer surface that sealingly engages the throat to the socket to thereby trap air in the socket when inserted there into. This trapped air is compressed as the ball is forced into the socket through the throat 32 providing an air cushion. Any attempt to swing the door in the opposite directions is initially resisted by the trapped air in the socket as the ball is forced out of the socket through the throat.

The amount of compression and force to overcome the suction can be varied by variously controlling leakage of air from the socket and/or the amount of air trapped in the air chamber. One for example can vary the distance of travel of the ball while remaining in sealing contact with the throat into the socket. This might be done by changing the ratio of the diameter of the ball to that of the socket throat. Another would be to have the throat continue as a cylindrical portion part way into the cavity before the wall 34 of the cavity tapers outwardly as illustrated in the drawing. The air leakage can also be controlled by having dimples on the outer surface of the ball similar to that of a golf ball.

A modified embodiment is illustrated in FIGS. 2 and 3 wherein an open ended sleeve 60 of resilient material is inserted into a rigid sleeve 70. The sleeve 70 has a closed bottom wall 71 and the volume of the air chamber in this case can be selectively varied by sliding the sleeve 60 further inwardly toward or away from the bottom wall 71 of the sleeve 70. The sleeve 60 has a central bore 61 that tapers outwardly in a direction from an entry throat 62 thereof toward the outer sleeve bottom wall 71. The wall surface that defines the bore 61 maybe ribbed as illustrated in FIG. 2 or smooth as is the case of the embodiment illustrated in FIG. 1.

The foregoing ball and socket can be employed in many different ways other than just a door stop described above.

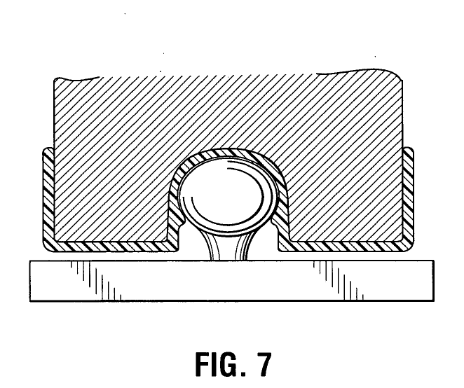

The ball member for example maybe atop a post or plate attached to a post and the socket member fastened to a suitable area on a portable lantern, for example the bottom thereof so that it can be removably and variously positioned to shine on different areas or removed for hand use. FIG. 7 shows a cutaway view of the lamp base and lamp of FIG. 6 wherein the ball is biased and held by the constriction of the socket.

The foregoing detailed description is given primarily for clearness of understanding and no unnecessary limitations are to be understood therefrom, for modifications will become obvious to those skilled in the art based upon more recent disclosures and may be made without departing from the spirit of the invention and scope of the appended claims.

We claim:

1. A ball and socket coupling assembly for detachably interconnecting a pair of members, comprising:
a first ball-shaped member;
means on said first member for securely attaching said first member to one of a pair of members;
a socket member having a cavity for receiving therein said first member;
means on said second member for securely attaching same to said other one of said pair of members;
said socket member having a throat entry into said cavity and wherein said first ball-shaped member has an outer dimension greater than that of at least a portion of said throat providing an interference fit during insertion and removal of said first ball-shaped member respectively into and out of said cavity of said socket member.

2. The ball and socket coupling assembly as defined in claim 1 wherein at one of said throat and an outer surface of said first member is made of a resilient material.

3. The ball and socket coupling assembly member as defined in claim 1 including means controllably releasing air from said socket when said first member is moved into and out of the same.

4. The ball and socket coupling assembly as defined in claim 2 including means controllably releasing air from said socket when said first member is moved into and out of the same.

5. The ball and socket coupling assembly as defined in claim 1 wherein said second member comprises an outer rigid sleeve member having one end thereof closed and open ended sleeve of resilient material inserted into said rigid sleeve.

6. The ball and socket coupling assembly as defined in claim 4 wherein said air release means comprises dimples on the outer surface of said first member.

7. The ball and socket coupling assembly as defined in claim 1 wherein said first member is spherical.

8. The ball and socket coupling assembly as defined in claim 1 wherein said first member is elliptical.

9. The ball and socket coupling assembly as defined in claim 1 wherein said first member is cylindrical having an interior portion of a larger diameter.

10. The ball and socket coupling assembly as defined in claim 2 wherein said open ended sleeve is selectively adjustably moveable in said rigid sleeve for movement in a direction toward and away from the closed end thereof.
